(19) United States
(12) Patent Application Publication
(10) Pub. No.: US 2018/0315008 A1
(43) Pub. Date: Nov. 1, 2018

(54) APPARATUS AND METHOD FOR DETERMINING ORDER QUANTITIES IN SUPPLY NETWORKS

(71) Applicant: General Electric Company, Schenectady, NY (US)

(72) Inventors: Peter Koudal, Niskayuna, NY (US); Walter Yund, Niskayuna, NY (US); John Carbone, Niskayuna, NY (US); Joseph Salvo, Schenectady, NY (US); Patricia Denise Mackenzie, Clifton Park, NY (US)

(21) Appl. No.: 15/716,980

(22) Filed: Sep. 27, 2017

Related U.S. Application Data
(60) Provisional application No. 62/492,029, filed on Apr. 28, 2017.

(51) Int. Cl. G06Q 10/08

(52) U.S. Cl. CPC G06Q 10/087

(57) ABSTRACT

An optimum order quantity (OOQ) of the material or component using received data is dynamically determined in real-time. An optimum proposed fulfillment timing for filling open purchase orders of the material or component using the received data is determined. The OOQ and optimum proposed fulfillment timing are rendered to a supply chain owner/materials manager at a graphical electronic display. The OOQ and the optimized proposed fulfillment timing are re-determined as additional data is received and by utilizing the new order quantity.

### BACKGROUND OF THE INVENTION

### Field of the Invention

The subject matter disclosed herein generally relates to supply networks, and, more specifically, to determining order quantities within these networks.

### Brief Description of the Related Art

Ensuring the optimal flow of goods or services in a complex global supply network is one of the greatest challenges in global supply chains. With tens of thousands of parts, hundreds or thousands of suppliers and facilities, multiple manufacturing and warehousing locations, materials and supply chain managers struggle to manage an almost insurmountable amount of information and variability in supply. Planning and executing materials supply through purchase orders and delivery from a diverse set of suppliers, materials, and capabilities, is very difficult at best.

Planning parameters, such as optimal order quantity, are utilized during the execution of the supply chain system. However, this parameter is often misaligned with actual performance of suppliers over time and or with an optimized quantity. Misalignment can result in excess inventory or slow-moving/non-moving inventory if the current order quantity is too high or the placement of frequent orders, causing churn and excess costs if the current order quantity is too low.

### BRIEF DESCRIPTION OF THE INVENTION

The present invention is directed to providing users (e.g., managers and staff) in a supply chain (e.g., at a warehouse, manufacturing operation, or delivery operation) the ability to rapidly identify, prioritize and effect changes to both the information, finance and physical flow of goods in the supply of their business. This invention allows a planner/buyer to determine the Optimum Order Quantity (OOQ) for a given material, as determined by supply chain parameters and recent supply chain performance, and detect when it is misaligned with either the current order quantity in the planning system or the observed order quantity as found in actual placed purchased orders. User interaction is provided in several ways, including the ability to investigate a given material (or part), or to examine an entire portfolio of materials (or parts), or a subset of that portfolio.

The present invention improves the supply chain performance by dynamically adjusting parameters such as OOQ to ensure a sound basis for decision making. This invention provides supply chain materials managers with real-time information on actual performance versus a plan, and automatically indicates parameters that need adjustment to improve delivery performance as well as other key performance indicators (KPIs), such as inventory.

In many of these embodiments, data relating to the demand and inventory of a material or component used by a customer is received. An optimum order quantity (OOQ) of the material or component using the received data is dynamically determined in real-time. An optimum proposed fulfillment timing for filling open purchase orders of the material or component using the received data is determined. The OOQ and optimum proposed fulfillment timing are rendered to the customer at a graphical electronic display.

The order quantity is selectively changed to a new order quantity based upon the OOQ and the optimum proposed fulfillment timing. A timing of execution of the open purchase orders is also selectively changed based upon the OOQ and the optimum proposed fulfillment timing. The OOQ and the optimized proposed fulfillment timing are re-determined as additional data is received and by utilizing the new order quantity.

In examples, the received data is one or more of current inventory data, safety stock data, usage data, demand data, sourcing data, material data, or data received from user controls. Other examples are possible.

In other examples, an optimum inventory entitlement is determined and the optimum inventory entitlement compared is rendered against a current inventory to a supply chain owner/materials manager on the graphical electronic display. In aspects, the optimum inventory entitlement utilizes the safety stock data.

In still other examples, the graphical electronic display is disposed at a personal computer, a laptop, a tablet, or a cellular phone. Other examples are possible.

In examples, the above-mentioned approach is performed at the cloud. Other examples are possible.

In other examples, the received data is received from user controls. The received data includes a cost of capital, a purchase order process cost, an inventory carrying cost, or a material type. Other examples are possible.

In others of these embodiments, an apparatus includes an electronic interface and a control circuit. The electronic interface has an input and an output, and is configured to receive data at the input relating to the demand and inventory of a material or component used by a customer. The data is received from an electronic network.

The control circuit is coupled to the electronic interface, and is configured to dynamically and in real-time determine an optimum order quantity (OOQ) of the material or component using the received data. The control circuit is further configured to determine an optimum proposed fulfillment timing for filling open purchase orders of the material or component using the received data, and render the OOQ and optimum proposed fulfillment timing from the supplier at a graphical electronic display via the output. The control circuit is further configured to selectively change the order quantity to a new order quantity based upon the OOQ and the optimum proposed fulfillment timing.

The control circuit is additionally configured to selectively change a timing of execution of the open purchase orders based upon the OOQ and the optimum proposed fulfillment timing and to re-determine the OOQ and the optimized proposed fulfillment timing as additional data is received and by utilizing the new order quantity. The control circuit is further configured to communicate the fulfillment timing to a user via the output of the electronic interface.

In aspects, the control circuit is configured to determine an optimum inventory entitlement and render the optimum inventory entitlement compared against a current inventory to the customer on the graphic electronic display. In examples, the optimum inventory entitlement is determined at least in part by utilizing the safety stock.

In other examples, the graphical electronic display is disposed at a personal computer, a laptop, a tablet, or a cellular phone. In other aspects, the apparatus is deployed at the cloud. Other examples are possible.

### BRIEF DESCRIPTION OF THE DRAWINGS

For a more complete understanding of the disclosure, reference should be made to the following detailed description and accompanying drawings wherein:

FIG. 1 comprises a diagram of a system for determining optimal order quantity and inventory entitlement according to various embodiments of the present invention;

FIG. 2 comprises a diagram of another example of a system for determining optimal order quantity according to various embodiments of the present invention;

FIG. 3 comprises a flowchart of an approach for determining system, observed and optimal order quantity and inventory entitlement according to various embodiments of the present invention;

FIG. 4 comprises a flowchart of an approach to determine OOQ values and entitlement values according to various embodiments of the present invention;

FIG. 5 comprises a flowchart of one example of an approach for determining potential actions according to various embodiments of the present invention;

FIG. 6A is a diagram of a display screen showing obscured order quantity minus system order quantity according to various embodiments of the present invention;

FIG. 6B is a diagram of a display screen showing part number and inventory value minus entitlement according to various embodiments of the present invention; and

FIG. 6C is a diagram of a display screen showing inventory parts and order quantity according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

The approaches described herein provide managers and staff in a supply chain (e.g., at a warehouse, manufacturing operations, or the delivery operations) the ability to rapidly identify, prioritize and effect changes to both the information, finance and physical flow of goods in the supply of their business. These approaches leverage available information across the supply network including (for example) planned order quantities, actual order quantities from placed purchase orders, recent usage, unit cost, total purchase volume, transportation costs, ordering costs, lot sizes, material criticality, shelf life, and models of the data through a system of algorithms.

The approaches described herein allow raw data in the supply base to be efficiently analyzed and optimized for decision-making purposes. With these approaches, for example, a planner/buyer planning to buy a material is presented with the optimum order quantity as recommended, based on analysis of various data. This quantity is also compared to the current value in the planning system and to the actual observed value as detected from recent purchases. This enables the best decision to be made in terms of adjusting the order quantity to ensure a cost-effective supply of material or part.

In the absence of the approaches described herein, manufacturing operations will continue to struggle to keep an optimized, cost-effective supply on hand for meeting material requirements and production requirements for satisfying customer demand on time. The approaches described herein solve these and other problems.

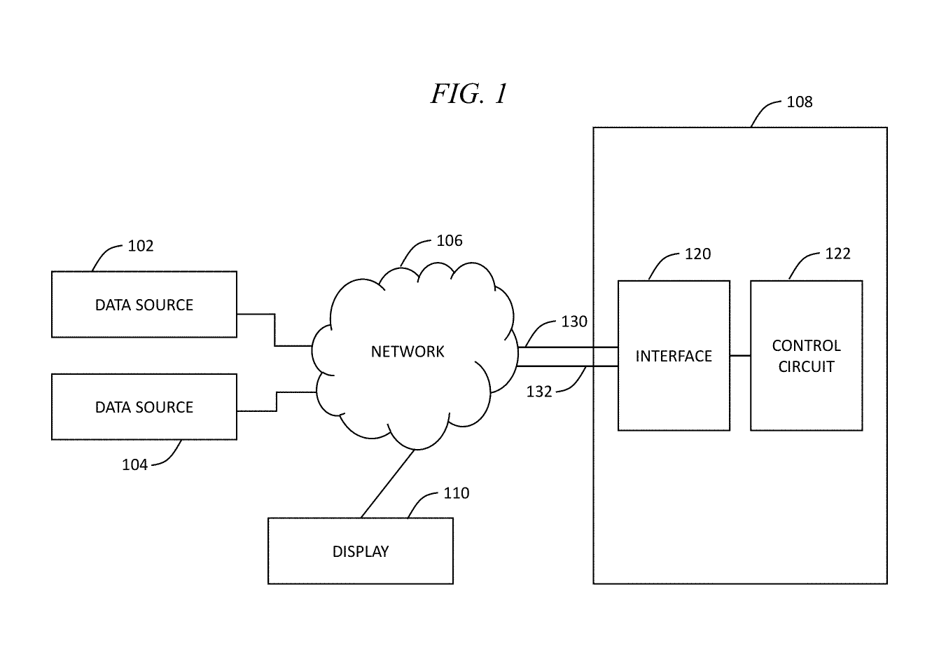

Referring now to FIG. 1, one example of a system 100 for determining optimal order quantity and inventory entitlement cost analysis is described. The system includes data sources 102 and 104, a network 106, an apparatus 108 coupled to the network 106, and a graphical electronic display 110. The apparatus 108 includes an electronic interface 120 and a control circuit 122.

The data sources 102 and 104 may be electronic devices (e.g., memories, other data storage devices, processors, communication devices, or any combination of these or other electronic devices) supplying different types of information or data. In examples, the data may include current inventory data for a material, safety stock data for a material, usage data for a material, demand data for a material, sourcing data for a material, material data, or data received from user controls (e.g., from the graphical electronic display 110). Although two data sources are shown it will be appreciated that any number of data sources are possible. Also, the data sources may be located at suppliers, at manufacturing sites, at factories, at customer sites, at central processing centers, at home offices, at business centers, or at any other location.

The network 106 may be any type of electronic communication network or combination of networks. The network 106 may include devices such as gateways, routers, or processors. In one example, the network 106 is the cloud.

The graphical electronic display 110 is any device that is configured to produce or render a display with information to a user. In examples, the graphical electronic display 110 is disposed on a personal computer, a laptop, a tablet, or a cellular phone. Other examples are possible.

The electronic interface 120 may be any combination of hardware and software, and includes an input 130 and an output 132. In examples, the electronic interface 120 is configured to receive data (via the input 130) and transmit data (via the output 132). The electronic interface 120 may also provide formatting and conversion functions.

The control circuit 122 is coupled to the electronic interface, and is configured to dynamically and in real-time determine an optimum order quantity (OOQ) of the material or component using the received data. It will be appreciated that as used herein the term “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 122 may be configured (for example, by using corresponding programming stored in a memory as will be well understood by those skilled in the art) to carry out one or more of the steps, actions, and/or functions described herein.

The control circuit 122 is further configured to determine an optimum proposed fulfillment timing for filling open purchase orders of the material or component using the received data (from the input 130), and to render the OOQ and optimum proposed fulfillment timing to the customer at a graphical electronic display 110 via the output 132. The control circuit 122 is further configured to selectively change the order quantity to a new order quantity at the based upon the OOQ and the optimum proposed timing. The control circuit 122 is configured to selectively change a timing of execution of the open purchase orders based upon the OOQ and the optimum proposed fulfillment timing and to re-determine the OOQ and the optimized proposed fulfillment timing as additional data is received and by utilizing the new order quantity. The control circuit 122 is configured to communicate the fulfillment timing to a user via the output 132 of the electronic interface 120.

In aspects, the control circuit 122 is configured to determine an optimum inventory entitlement and render the optimum inventory entitlement compared against a current inventory to a supply chain owner/materials manager on the graphic electronic display 110. In examples, the optimum inventory entitlement is determined at least in part by utilizing the safety stock.

In examples, the graphical electronic display 110 is disposed at a personal computer, a laptop, a tablet, or a cellular phone. In other aspects, the apparatus 108 is deployed at the cloud. Other examples of deployments are possible.

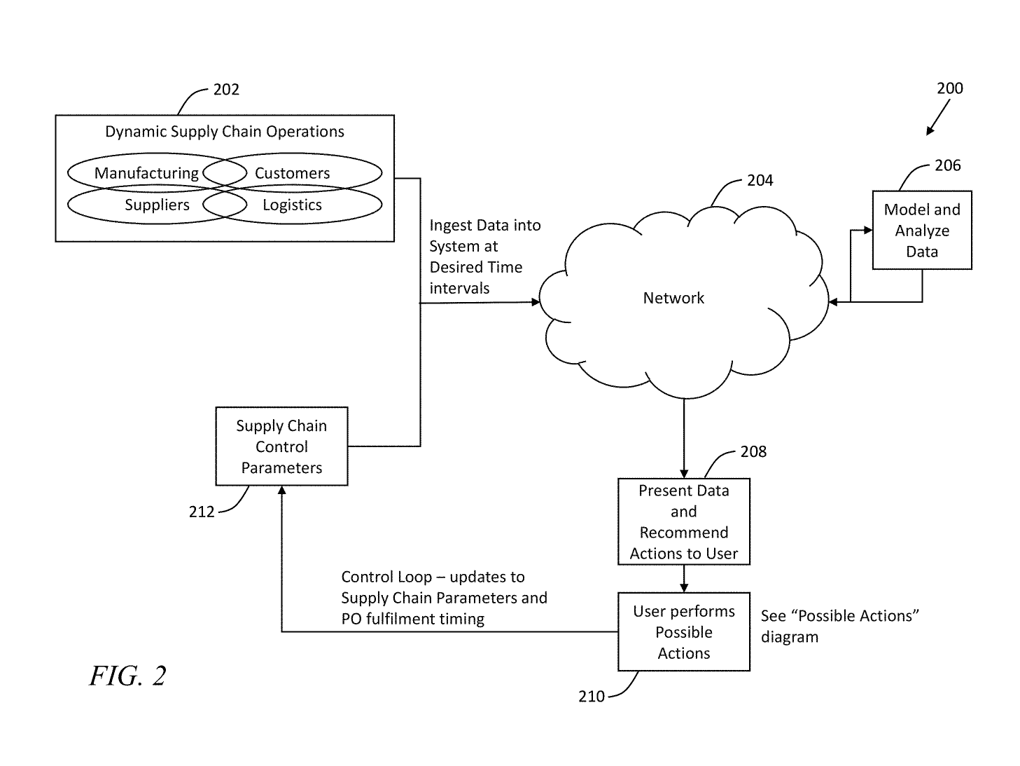

Referring now to FIG. 2, another example of a system 200 for determining order quantities is described. The system 200 includes a dynamic supply chain operations component 202 and a network 204. The dynamic supply chain operations component 202 includes various entities such as manufacturing enterprises, customers, suppliers, and logistic enterprises. The dynamic supply chain operations component 202 supplies data to the network 204.

At step 206, the data is modelled and analyzed, for example, by a control circuit (e.g., the control circuit 122 of FIG. 1). The data and recommended actions are presented to a user at step 208. At step 210, users perform possible actions. Updates to the supply chain parameters and purchase order timing are made at step 212. These updates are described in greater detail elsewhere herein.

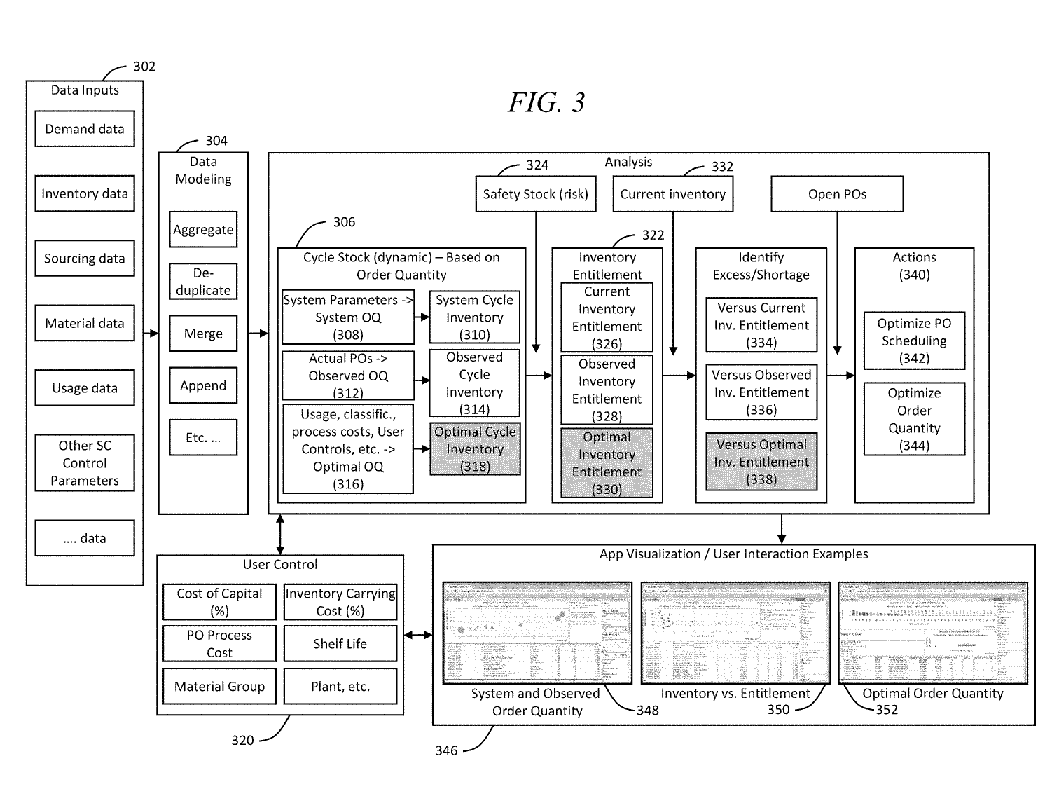

Referring now to FIG. 3, one example of an approach for determining optimal order quantity and optimizing PO scheduling is described. At step 302, data inputs are received. The data inputs may be from manufacturers, suppliers, customers, or logistic entities to mention a few examples. Additionally, the data inputs may come from devices such as personal computers, cellular phones, tablets, lap tops, processors, memories, or any other electronic sources. The data inputs may include demand data (how much product is being consumed), inventory data (at the site, in transit, at the customer, at the supplier), sourcing data (purchase orders), material data (safety stock data), and usage data. Other examples are possible.

At step 304, data modeling then occurs. The data modeling may include aggregating data, removing duplicate data, merging data, and appending data together (or adding additional information to existing data). Other examples are possible.

Analysis of the data then takes place. Cycle inventory generally is the amount of inventory above levels of safety stock. Cycle inventory, in examples, is on average about 50% of the order quantity since over time the cycle inventory depletes from the maximum cycle inventory to zero cycle inventory. During this cycle, for example, the expected average cycle inventory can be estimated to be half the maximum cycle inventory when the consumption of the inventory is assumed constant over the duration of the consumption from maximum cycle inventory to zero cycle inventory. Other examples are possible.

At step 306, different cycle inventory values are identified and determined. More specifically, system order quantity is determined at step 308 based on systems of record. This produces a system cycle inventory at step 310. System cycle inventory is a pre-set quantity that equals half the order quantity. Other examples are possible.

Observed order quantity is determined at step 312. This value is based upon an analysis of purchase orders and order quantities. Other factors may also be considered. The analysis may be an automatic analysis of purchase orders, in one example. Observed cycle inventory is determined at step 314, and may be derived from the purchase orders, or may be a predetermined fraction of the observed purchase orders. In one example, observed cycle inventory may be set equal to half the observed order quantity. Other examples are possible.

Based upon how much a customer has used, process costs, user input (cost of capital, how important the material/part is), an optimum order quantity (OOQ) is determined at step 316. This may be used at step 318 to determine a optimum cycle inventory, which may be a fraction of the OOQ. In one example, optimum cycle inventory may be set equal to half the optimum order quantity. Other examples are possible. It will be appreciated that the cycle inventory values change based upon the order quantity values. User controls 320 may supply some or all of this information.

At step 322 inventory entitlement is determined. In one approach, the following equation may be used:

Entitlement=Safety stock+Cycle inventory. Safety inventory 324 is a constant value that can be programmed by a user or can be determined dynamically.

Thus, simple addition will give the current, observed, and optimum inventory entitlement values 326, 328, and 330.

Current inventory 332 can be compared against these entitlements at steps 334, 336, and 338.

Then, optimized purchase order (PO) scheduling occurs at step 340. For new POs as well as open POs (POs that have yet to be fulfilled), at step 342 the timing of the purchase order may be determined and changed. For example, a delay to fill a purchase order may occur. At step 344, the quantity in the purchase order may be changed. For example, the order quantity may be changed to the OOQ (determined at step 316) or some other value selected by the user. The process of FIG. 3 may then be repeated so as to further fine-tune the OOQ.

Through the approach of FIG. 3, various visualizations can be presented to the user at step 346. For example, system and observed order quantities 348, inventory versus entitlement values 350, and optimal order quantity values 352 may be presented to users at displays. Other types of comparisons and other types of information may also be presented.

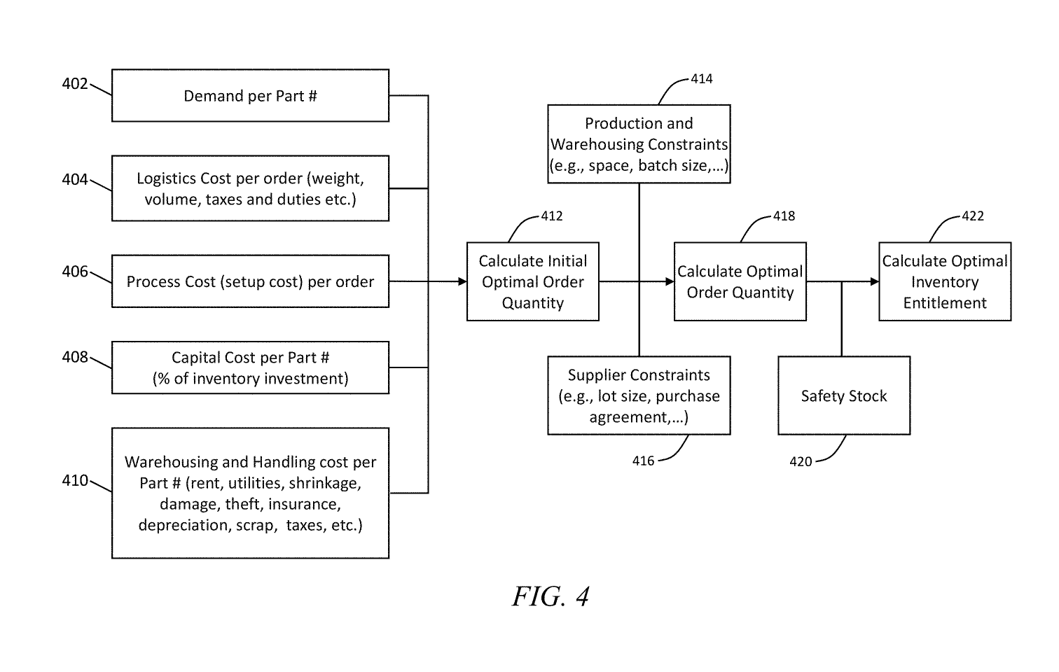

Referring now to FIG. 4, one example of determining OOQ and optimal inventory entitlement is described. It will be appreciated that this is one example approach and that other examples are possible.

Steps 402, 404, 406, 408, and 410 gather information that is used in determining an initial optimal order quality (OOQ). At step 402, the demand for a part number is obtained. The demand may be expressed as the number of units of the part needed per unit time.

At step 404, the logistics cost per order are determined for each order. The logistics costs may include the weight, volume, taxes, and duties associated with a product order. Other examples of logistics costs are possible.

At step 406, the process costs per order are obtained. For example, the set-up cost for an order is obtained. Other examples of process cost are possible.

At step 408, capital costs per part are obtained. This may be expressed as a percentage of inventory investment.

At step 410, the warehousing and handling costs per part are obtained. In examples, this factor may include the rent, utilities, shrinkage, damage, theft, insurances, depreciation, scrap value, and taxes. Other examples are possible.

At step 412, an initial OOQ is determined. As known to those skilled in the art, an equation may be used to determine the initial OOQ, considering all the inputs to determine the OOQ. In examples, different weights may be assigned to the different factors.

At step 414, production and warehousing constraints are obtained. For example, space constraints and batch size constraints are obtained.

At step 416, supplier constraints are obtained. These include lot size constraints or constraints in the purchase agreement.

At step 418, the initial OOQ is adjusted to obtain the OOQ. The adjustment is made by applying the constraints at steps 414 and 416. For example, a supplier may only be able to manufacture a certain number of parts over a given time period, and this factor may require an adjustment to the initial OOQ. In another example, a supplier may insist on a minimum order quantity based on a lot size it is economical for the supplier to make.

At step 420, a safety stock number is obtained. At step 422, optimal inventory entitlement is obtained. For example, cycle inventory may be determined as described above and added to the safety stock number.

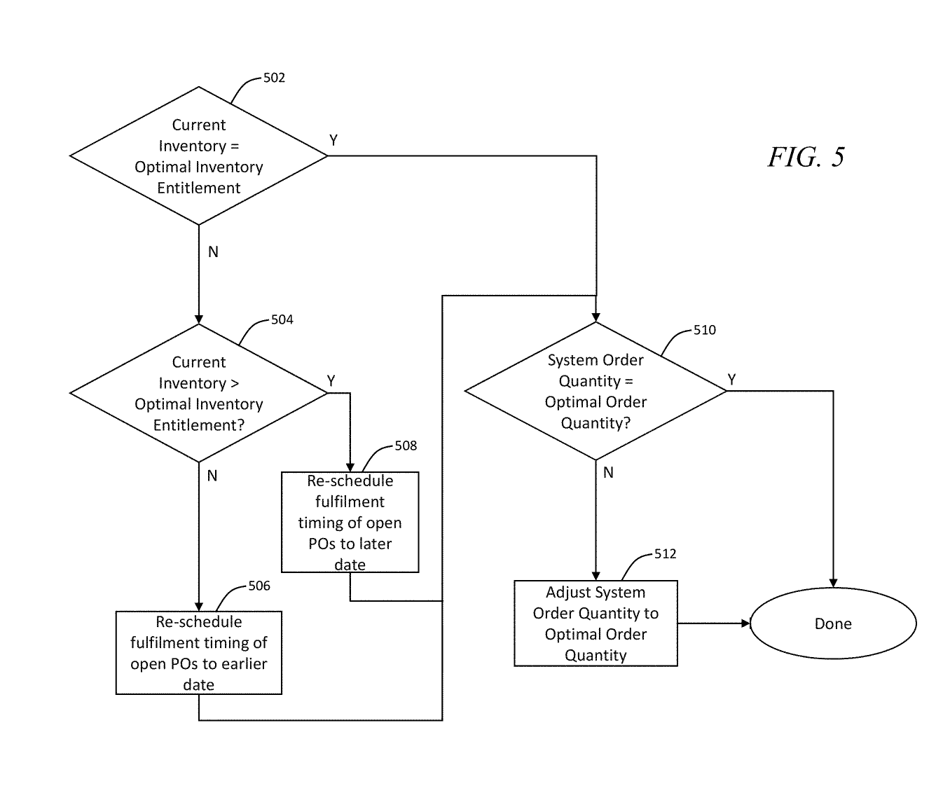

Referring now to FIG. 5, potential actions are determined based upon the various parameters that are calculated using these approaches. At step 502, a determination is made as to whether the current inventory is equal to the optimal inventory entitlement. If the answer is negative, at step 504, it is determined whether the current inventory is greater than the optimal inventory entitlement.

If the answer at step 504 is negative, execution continues at step 506 where the fulfillment timing of open purchase orders is rescheduled to an earlier date. Control continues at step 510.

If the answer at step 504 is affirmative, execution continues at step 508 where the fulfillment timing of open purchase orders is rescheduled to a later date. Control then continues at step 510.

At step 510, it is determined if the system order quantity is equal to the optimal order quantity. If the answer is affirmative, then execution is completed. If the answer at step 510 is negative, execution continues with step 512 where the system order quantity is adjusted to the optimal order quantity. Execution then is complete.

If the answer at step 502 is affirmative, then execution continues with step 508 where the fulfillment timing of the purchase orders is rescheduled. Execution continues with step 510 as has been described above.

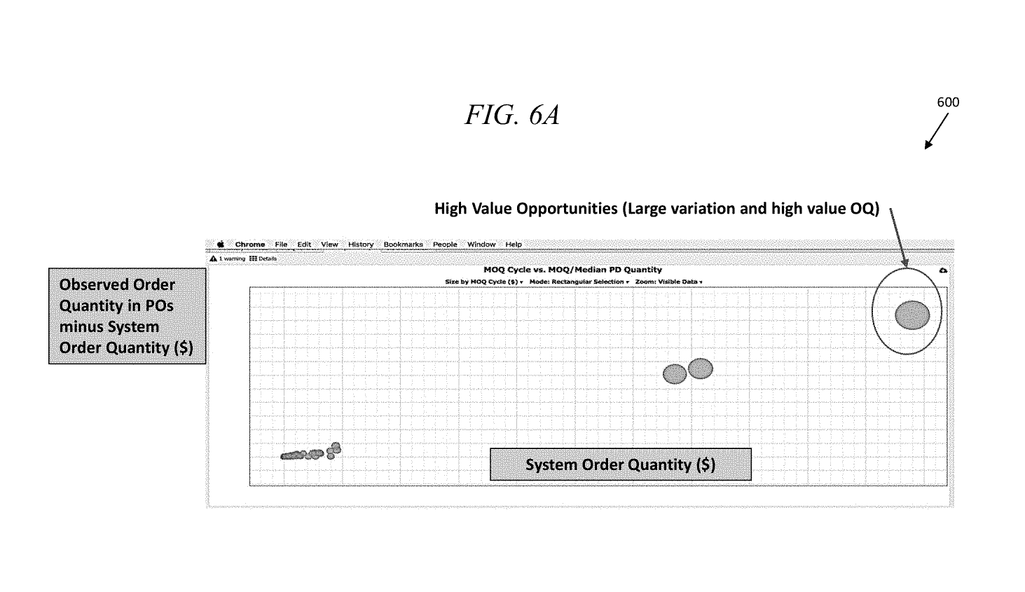

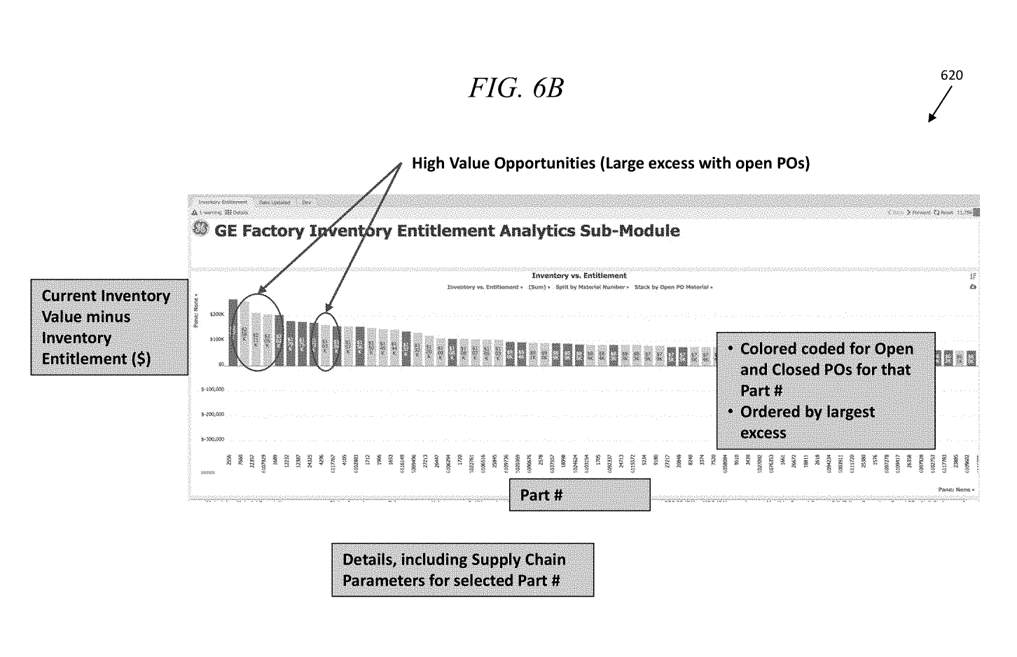

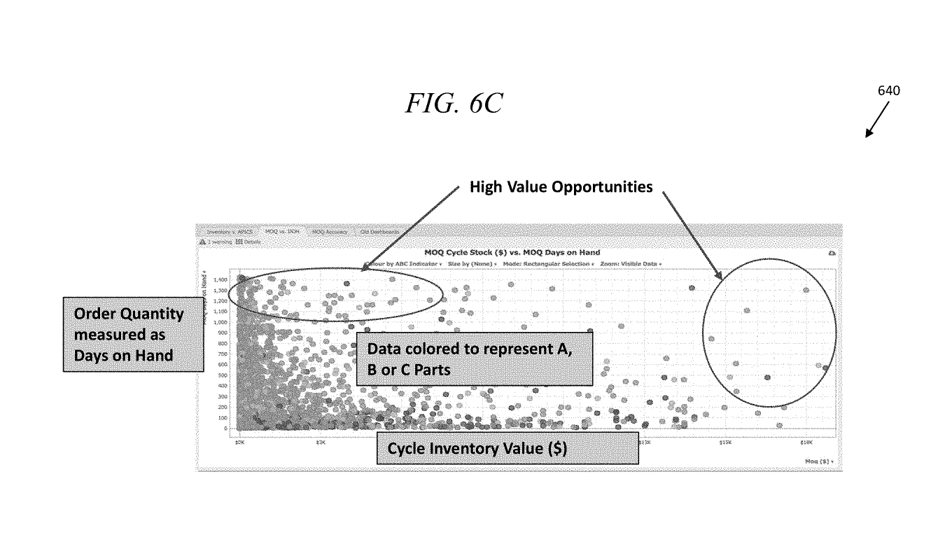

Referring now to FIGS. 6A, 6B, and 6C, some example user interface screens are shown. It will be appreciated that that these are example screens only and that other examples are possible.

In FIG. 6A, the y-axis of a display 600 represents observed order quantity in purchase orders minus system order quantity and the x-axis represents system order quantity, with both being in units of dollars. It can be seen that high value opportunities (a large variation between observed order quantity and system order quantity, and a high value order quantity) can be determined to exist by a viewer of the screen 600 (and in other examples, may be automatically determined).

In FIG. 6B, the x-axis of a display 620 represents a part number and the y-axis represents a current inventory value minus inventory entitlement (in dollars) for the part number. Parts can be color coded to indicate whether there is an open POs for that part. It can be seen that high value opportunities (large excess with open purchase orders) can be determined to exist by a viewer of the display 620 (and in other examples, may be automatically determined).

In FIG. 6C, a screen 640 may include a variety of dots, and each of the dots is colored in different colors to represent one of three different types of inventory parts. The y-axis represents order quantity measured as days on hand and the x-axis represents cycle inventory values. It can be seen that high value opportunities exist with high order quantities or high cycle inventories values, and these opportunities can be determined by a viewer of the screen 640 (and in other examples, may be automatically determined).

It will be appreciated by those skilled in the art that modifications to the foregoing embodiments may be made in various aspects. Other variations clearly would also work, and are within the scope and spirit of the invention. It is deemed that the spirit and scope of the invention encompasses such modifications and alterations to the embodiments herein as would be apparent to one of ordinary skill in the art and familiar with the teachings of the present application.

What is claimed is:

1. A method, comprising:
receiving data relating to the demand and inventory of a material or component used by a customer;
dynamically and in real-time determining an optimum order quantity (OOQ) of the material or component using the received data;
determining an optimum proposed fulfillment timing for filling open purchase orders of the material or component using the received data;
rendering the OOQ and optimum proposed fulfillment timing to the customer at a graphical electronic display;
selectively changing the order quantity to a new order quantity based upon the OOQ and the optimum proposed fulfillment timing;
selectively changing a timing of execution of the open purchase orders based upon the OOQ and the optimum proposed fulfillment timing;
re-determining the OOQ and the optimized proposed fulfillment timing as additional data is received and by utilizing the new order quantity.

2. The method of claim 1, wherein the received data is one or more of current inventory data, safety stock data, usage data, demand data, sourcing data, material data, or data received from user controls.

3. The method of claim 1, further comprising:
determining an optimum inventory entitlement and rendering the optimum inventory entitlement compared against a current inventory to a supply chain owner/materials manager on the graphical electronic display.

4. The method of claim 3, wherein determining the optimum inventory entitlement utilizes the safety stock.

5. The method of claim 1, wherein the graphical electronic display is disposed at a personal computer, a laptop, a tablet, or a cellular phone.

6. The method of claim 1, wherein the steps are performed at the cloud.

7. The method of claim 1, wherein the received data is received from user controls including a cost of capital, a purchase order process cost, an inventory carrying cost, or a material type.

8. An apparatus, comprising:
an electronic interface having an input and an output, the electronic interface being configured to receive data at the input relating to the demand and inventory of a material or component used by a customer, the data being received from an electronic network;
a control circuit coupled to the electronic interface, the control circuit configured to dynamically and in real-time determine an optimum order quantity (OOQ) of the material or component using the received data, the control circuit being further configured to determine an optimum proposed fulfillment timing for filling open purchase orders of the material or component using the received data, and rendering the OOQ and optimum proposed fulfillment timing to the customer at a graphical electronic display, the control circuit further configured to selectively change the order quantity to a new order quantity based upon the OOQ and the optimum proposed fulfillment timing, the control circuit configured to selectively change a timing of execution of the open purchase orders based upon the OOQ and the optimum proposed fulfillment timing and to re-determine the OOQ and the optimized proposed fulfillment timing as additional data is received and by utilizing the new order quantity, the control circuit configured to communicate the fulfillment timing to a user via the output of the electronic interface.

9. The apparatus of claim 8, wherein the received data is one or more of current inventory data, safety stock data, usage data, demand data, sourcing data, material data, or data received from user controls.

10. The apparatus of claim 8, wherein the control circuit is configured to determine an optimum inventory entitlement and render the optimum inventory entitlement compared against a current inventory to a supply chain owner/materials manager on the graphic electronic display.

11. The apparatus of claim 10, wherein determining the optimum inventory entitlement utilizes the safety stock.

12. The apparatus of claim 8, wherein the graphical electronic display is disposed at a personal computer, a laptop, a tablet, or a cellular phone.

13. The apparatus of claim 8, wherein the apparatus is deployed at the cloud.

14. The apparatus of claim 8, wherein the received data is received from user controls including a cost of capital, a purchase order process cost, an inventory carrying cost, or a material type.
